(19) United States
(12) Patent Application Publication
(10) Pub. No.: US 2025/0373894 A1
(43) Pub. Date: Dec. 4, 2025

(54) Methods, Systems, and Devices for Media Presentation Device Content Presence Determination

(71) Applicant: The Nielsen Company (US), LLC, New York, NY (US)

(72) Inventor: Joseph Nicholas Morelli, Rockville, MD (US)

(21) Appl. No.: 19/219,114

(22) Filed: May 27, 2025

Related U.S. Application Data
(60) Provisional application No. 63/652,972, filed on May 29, 2024.
(60) Provisional application No. 63/786,538, filed on Apr. 10, 2025.

(51) Int. Cl. H04N 21/443; H04N 21/845

(52) U.S. Cl. CPC H04N 21/4436; H04N 21/8456

(57) ABSTRACT

In one aspect, an example method is disclosed. The example method includes: (a) receiving power data associated with a media presentation device, wherein the power data is associated with a plurality of time intervals; (b) using at least the received power data to determine one or more rolling power metrics for each of the plurality of time intervals, wherein each of the one or more rolling power metrics is for a corresponding rolling time window; (c) using at least the determined one or more rolling power metrics to determine one or more corresponding prediction intervals, wherein each of the one or more corresponding prediction intervals corresponds to one of the one or more rolling power metrics; and (d) using at least the one or more corresponding prediction intervals to determine a content presence state for the media presentation device for one or more of the plurality of time intervals.

### CROSS-REFERENCE TO RELATED APPLICATIONS

This application is a non-provisional of, and claims priority to, U.S. Provisional Pat. App. No. 63/786,538 filed Apr. 10, 2025 and U.S. Provisional Pat. App. No. 63/652,972 filed May 29, 2024, each of which is hereby incorporated by reference herein in its entirety.

### SUMMARY

In one aspect, an example method is disclosed. The example method includes: (a) receiving power data associated with a media presentation device, wherein the power data is associated with a plurality of time intervals; (b) using at least the received power data to determine one or more rolling power metrics for each of the plurality of time intervals, wherein each of the one or more rolling power metrics is for a corresponding rolling time window; (c) using at least the determined one or more rolling power metrics to determine one or more corresponding prediction intervals, wherein each of the one or more corresponding prediction intervals corresponds to one of the one or more rolling power metrics; and (d) using at least the one or more corresponding prediction intervals to determine a content presence state for the media presentation device for one or more of the plurality of time intervals.

In another aspect, an example tangible, non-transitory computer readable medium is disclosed. The example tangible, non-transitory computer readable medium includes instructions that, when executed, cause at least one processor to perform a set of operations including: (a) receiving power data associated with a media presentation device, wherein the power data is associated with a plurality of time intervals; (b) using at least the received power data to determine one or more rolling power metrics for each of the plurality of time intervals, wherein each of the one or more rolling power metrics is for a corresponding rolling time window; (c) using at least the determined one or more rolling power metrics to determine one or more corresponding prediction intervals, wherein each of the one or more corresponding prediction intervals corresponds to one of the one or more rolling power metrics; and (d) using at least the one or more corresponding prediction intervals to determine a content presence state for the media presentation device for one or more of the plurality of time intervals.

In another aspect, an example computing system is disclosed. The example computing system includes: (a) at least one processor; and (b) tangible, non-transitory computer readable medium including instructions that, when executed, cause the at least one processor to perform a set of operations including: (a) receiving power data associated with a media presentation device, wherein the power data is associated with a plurality of time intervals; (b) using at least the received power data to determine one or more rolling power metrics for each of the plurality of time intervals, wherein each of the one or more rolling power metrics is for a corresponding rolling time window; (c) using at least the determined one or more rolling power metrics to determine one or more corresponding prediction intervals, wherein each of the one or more corresponding prediction intervals corresponds to one of the one or more rolling power metrics; and (d) using at least the one or more corresponding prediction intervals to determine a content presence state for the media presentation device for one or more of the plurality of time intervals.

### BRIEF DESCRIPTION OF THE DRAWINGS

FIG. 1 illustrates a simplified block diagram of an example computing device.

FIG. 2 illustrates a simplified block diagram of an example content presence determination system in which certain embodiments may be employed.

FIG. 3 illustrates a block diagram of an example content presence determination technique in accordance with example embodiments.

FIG. 4 illustrates an example of applying prediction intervals in accordance with example embodiments.

FIG. 5 illustrates a flow chart of an example method of certain embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

In this disclosure, unless otherwise specified and/or unless the particular context clearly dictates otherwise, the terms “a” or “an” mean at least one, and the term “the” means the at least one.

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments may be utilized and other changes may be made without departing from the scope of the subject matter presented herein.

Accordingly, the example embodiments described herein are not meant to be limiting. It will be readily understood that the aspects of the present disclosure, as generally described herein, and illustrated in the figures, may be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

This disclosure describes various techniques for media presentation device content presence determination. More particularly, as discussed below, disclosed embodiments provide for determining a likelihood of whether content was provided during a particular time period by a media presentation device. Media presentation devices may include, for example, televisions, computer monitors, projectors, smart displays, computers, gaming devices, smart speakers, radios, set top boxes, streaming media players, audio visual receivers, etc. For example, during a particular time period, a media presentation device may be turned off and not presenting content. As another example, during a particular time period, a media presentation device may be turned on but may not be presenting content and, instead, may be presenting a home screen, menu, screen saver, etc. As another example, during a particular time period, a media presentation device may be turned on and presenting content, such as audio content and/or video content.

In some examples, an audience measurement system is improved by determining whether a media presentation device is presenting content at a particular time. An audience measurement system may perform operations related to audience measurement in connection with the presentation and/or consumption of media content. In one aspect, this may involve the audience measurement system using one or more media content identification techniques to identify what media content is being presented to and/or consumed by a user and when that is occurring. The audience measurement system may use various techniques to do this. For example, the audience measurement system may include a metering device positioned near a television or other media presentation device of a user, such that the metering device may be exposed to audio output by a speaker of the television. The metering device may then extract a watermark embedded in an audio component of the presented media content and/or generate fingerprint data from the presented media content. The watermark and/or fingerprint data may be used by the audience measurement system as a basis to identify that media content.

In some examples, a metering device may be used in an audience measurement system to identify media content being presented to and/or consumed by an audience. In examples, a metering device may record, analyze, and send information about monitored media content to an identification server in the audience measurement system to identify the media content. For example, the metering device may send a copy of the media content that has been recorded, one or more watermarks detected in the media content, and/or one or more fingerprints generated based on the media content, any, some, or all of which may be used to aid in identification of the content being presented to the audience. The identification of media content in an audience measurement system may happen, for example, in real-time, near real-time, or at a later time, such as in overnight batch processing. For example, a metering device may simultaneously, or near simultaneously, record, analyze, and send information about monitored media content to an identification server. As another example, a metering device may store, for example, 1 hour, 2 hours, 4 hours, 12 hours, or 24 hours of information before sending it the identification server for processing. Thus, in the present disclosure, when discussing determination of whether a media presentation device is present media at a particular time, it should be understood that this may be a retrospective determination.

For various reasons, it can be difficult to determine whether a media presentation device is providing content during a particular time period, which in turn can result in untimely, inconsistent, and/or inaccurate audience measurement analysis. The disclosed techniques can help address these and other issues.

In some examples, the metering device includes one or microphones that are used to monitor audio content. In examples, the audio content may not be able to be reliably identified during at least some time intervals. For example, a microphone of the metering device may not be optimally placed and/or oriented to receive the audio content; there may be obstructions between a microphone and a media presentation device; and/or a microphone of the metering device may be clogged, resulting in insufficient signal that degrades and/or prevents content identification during at least some time intervals. As another example, the media presentation device may be muted or being used at a low volume, resulting in insufficient signal that degrades and/or prevents content identification during at least some time intervals. As another example, there may be other sources of sound that add noise (for example, ambient noise, mechanical system noise, environmental noise outside of a house, etc.), interference, etc. that degrades and/or prevents content identification during at least some time intervals. As another example, physical room conditions may distort, dampen, cause echoes, reflections, etc. that degrades and/or prevents content identification during at least some time intervals. As another example, the metering device may fail to capture audio content due to an intermittent component failure; power failure; data connectivity failure; storage issues; user interference; a software failure or bug; configuration error; and/or compatibility issues, resulting in insufficient signal that degrades and/or prevents content identification during at least some time intervals.

In some examples, the metering device includes a sensor that is used to monitor video content. In examples, the video content may not be able to be reliably identified during at least some time intervals. For example, a sensor of the metering device may not be optimally placed and/or oriented to receive the video content; there may be obstructions between the sensor and a media presentation device; and/or the sensor of the metering device may be dirty, resulting in insufficient signal that degrades and/or prevents content identification during at least some time intervals. As another example, the metering device may fail to capture video or image content due to an intermittent component failure; power failure; data connectivity failure; storage issues; user interference; a software failure or bug; configuration error; and/or compatibility issues, resulting in insufficient signal that degrades and/or prevents content identification during at least some time intervals.

When an audience measurement system is not able to reliably identify content being presented by a media presentation device, audience measurement reliability and quality are reduced. In some examples, additional sources of information may be used to increase the confidence that content was, or was not, being presented when, for example, the audience measurement system is not able to reliably identify content. In some audience measurement systems, additional devices may be provided to, for example, determine whether a media presentation device is operating (that is, whether it is powered on or off). However, while knowing whether or not the media presentation device is drawing power is a useful data point, it is not sufficient to indicate whether or not content was being presented. For example, a television may have been left on a home screen and not tuned to a particular channel. As another example, a streaming device may be showing a screensaver rather than presenting media content. As another example, each device may be different, with different levels of power draw for different power states (such as off, screen saver, menu, content, etc.) with overlap in the amount of power draw in those various power states, such that knowing an amount of power draw alone is not sufficient to identify whether or not content is being presented. Thus, improved techniques for media presentation device content presence determination are needed.

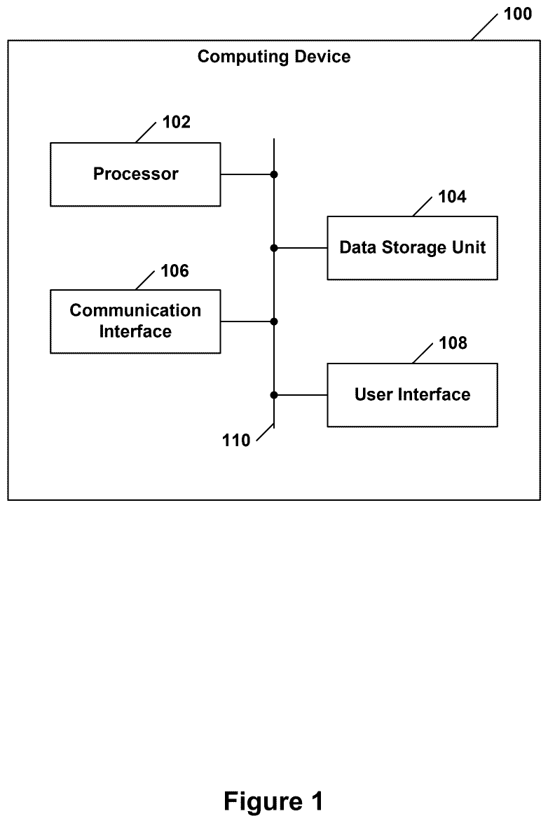

FIG. 1 illustrates a simplified block diagram of an example computing device 100. Computing device 100 may perform various acts and/or functions, such as those described in this disclosure. Computing device 100 may include various components, such as processor 102, data storage unit 104, communication interface 106, and/or user interface 108. These components may be connected to each other (or to another device, system, or other entity) via connection mechanism 110.

Processor 102 may include a general-purpose processor (for example, a microprocessor) and/or a special-purpose processor (for example, a digital signal processor (“DSP”)).

Data storage unit 104 may include one or more volatile, non-volatile, removable, and/or non-removable storage components, such as magnetic, optical, or flash storage, and/or may be integrated in whole or in part with processor 102. Further, data storage unit 104 may take the form of a non-transitory computer-readable storage medium, having stored thereon program instructions (for example, compiled or non-compiled program logic and/or machine code) that, when executed by processor 102, cause computing device 100 to perform one or more acts and/or functions, such as those described in this disclosure. As such, computing device 100 may be configured to perform one or more acts and/or functions, such as those described in this disclosure. Such program instructions may define and/or be part of a discrete software application. In some instances, computing device 100 may execute program instructions in response to receiving an input, such as from communication interface 106 and/or user interface 108. Data storage unit 104 may also store other types of data, such as those types described in this disclosure.

Communication interface 106 may allow computing device 100 to connect to and/or communicate with another other entity according to one or more protocols. In one example, communication interface 106 may be a wired interface, such as an Ethernet interface or a high-definition serial-digital-interface (“HD-SDI”). In another example, communication interface 106 may be a wireless interface, such as a radio, cellular, or WI-FI® interface. In this disclosure, a connection may be a direct connection or an indirect connection, the latter being a connection that passes through and/or traverses one or more entities, such as a router, switcher, or other network device. Likewise, in this disclosure, a transmission may be a direct transmission or an indirect transmission. Further, the term “connection mechanism” as used therein refers to one or more mechanisms that facilitate communication between two or more components, devices, systems, or other entities. A connection mechanism may be a relatively simple mechanism, such as a cable or system bus, or a relatively complex mechanism, such as a packet-based communication network (for example, the Internet). In some instances, a connection mechanism may include a non-tangible medium (for example, in the case where the connection is wireless).

User interface 108 may facilitate interaction between computing device 100 and a user of computing device 100, if applicable. As such, user interface 108 may include input components such as a keyboard, a keypad, a mouse, a touch sensitive panel, a microphone, and/or a camera, and/or output components such as a display device (which, for example, may be combined with a touch sensitive panel), a sound speaker, and/or a haptic feedback system. More generally, user interface 108 may include hardware and/or software components that facilitate interaction between computing device 100 and the user of the computing device 100.

In this disclosure, the term “computing system” means a system that includes at least one computing device, such as computing device 100. A computing system and/or components thereof may perform various acts, such as those set forth below.

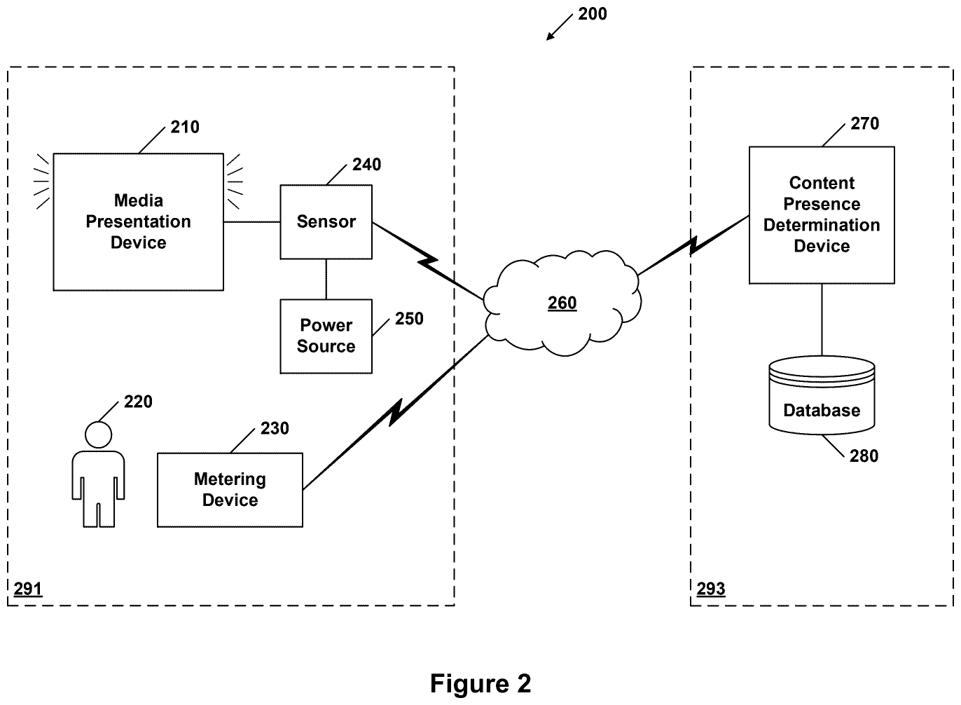

FIG. 2 illustrates a simplified block diagram of an example content presence determination system 200 in which certain embodiments may be employed. In particular, FIG. 2 shows the example content presence determination system incorporated into an audience measurement system, although it should be understood that other applications are possible. In an example embodiment, the content presence determination system 200 includes a media presentation device 210, an audience member 220, a metering device 230, a sensor 240, a power source 250, a content presence determination device 270, and a database 280.

As shown in FIG. 2, there is a first box 291 that encompasses the media presentation device 210, the audience member 220, the metering device 230, the sensor 240, and the power source 250 and a second box 293 that encompasses the content presence determination device 270 and the database 280. Although box 291 and box 293 are shown as two separate locations or environments, it would be understood by one of ordinary skill in the art that one or more of the components in box 291 could be in box 293 and that one or more of the components in box 293 could be in box 291 and that these components could be arranged in other ways. In some examples, box 291 may represent a media exposure environment, such as a house of the audience member 220 or a living room, kitchen, or bedroom of the house of the audience member 220. As another example, the media exposure environment may be outside of the house of the audience member 220, such a theater, bar, restaurant, or a house of another audience member. In some examples, box 293 may represent one or more data collection facilities, which may be, for example, associated with an audience measurement entity. In some examples, the one or more data collection facilities are remote from the media exposure environment. In some examples, the content presence determination device 270 (and, in some examples, also the database 280) may be part of, contained in, executing on, and/or incorporated into another device, such as metering device 230 or the sensor 240, for example. Other combinations of components are possible.

In an aspect, in examples, the media presentation device 210 streams, broadcasts, and/or otherwise outputs media content such as audio content and/or video content. For example, the media presentation device 210 may provide audio content by itself or as part of video content. The media presentation device 210 may include, for example, a television, a computer monitor, a projector, a smart display, a computer, a gaming device, a smart speaker, a radio, a set top box, a streaming media player, an audio visual receiver, etc. The media presentation device 210 may be implemented using and/or include a computing system, such as computing system 100, for example. The media content may include, for example, a television show, a movie, a video game, or music. In examples, the content provided by the media presentation device 210 may be presented to and/or consumed by one or more audience members, such as audience member 220.

In examples, the audience member 220 may be one of several audience members (not specifically illustrated in FIG. 2) that consume media content from the media presentation device 210. For example, the audience member 220 may watch a movie or listen to a radio program provided by the media presentation device 210.

In examples, metering device 230 monitors media content provided by the media presentation device 210 (and consumed by the audience member 220) to support identification of the media content by the audience measurement system. In examples, the metering device may be implemented using and/or include a computing device, such as computing device 100, for example. In some examples, the metering device 230 monitors the media content by capturing audio content outputted by, from, or in conjunction with the media presentation device 210 using one or more microphones or other audio sensing devices. For example, the metering device 230 may include a microphone oriented towards the speakers or other audio output of the media presentation device 210 to capture the audio content.

In examples, the metering device 230 records the audio captured from the media presentation device 210 and undertakes one or more identification protocols (for example, fingerprinting, comparative fingerprinting analysis, and/or watermarking) to assist in identification of the audio content. In some examples, fingerprint data may be generated based on the captured audio content. For example, the metering device 230 may include a processor for generating representations the audio content. In some examples, these representations may include one or more fingerprints and/or sub-fingerprints that are generated to represent the audio content. As another example, the metering device 230 may utilize a separate device (not shown) to generate the fingerprint data for the captured audio content. In some examples, the metering device 230 extracts watermark data embedded in the captured audio content. Using identification data including, at least, the fingerprint data and/or watermark data, the metering device 230 may attempt to identify the associated piece of media content.

In some examples, the metering device 230 may communicate the identification data to an identification server (not shown) of the audience measurement system. For example, the identification server may be implemented using and/or include a computing device, such as computing device 100, that processes the identification data to attempt to identify the associated piece of media content. In other examples the identification data is communicated to another server (not shown). In some examples, the metering device 230 may be configured to communicate the identification data to the identification server over network 260. In some instances, the metering device 230 communicates over network 260 using a communication interface, such as communications interface 106. For example, network 260 may include a wired and/or wireless network. As another example, network 260 may include a radio network, a cellular network, and/or the Internet. In some examples, the identification data may be communicated by a separate device (not shown), such as the separate device used by the metering device 230 to generate the fingerprint data.

In some examples, the identification data includes other data. For example, the identification data may include signal-to-noise (SNR) data. The SNR data represents a measure of signal strength relative to background noise in the audio captured by the metering device 230, for example.

In examples, the sensor 240 measures, detects, samples, or otherwise receives and/or determines power data about the power consumed by the media presentation device 210 from the power source 250. The sensor 240 may be implemented using and/or include a computing device, such as computing device 100, for example. The power source 250 may be a standard electrical outlet, for example. The sensor 210 may, for example, be coupled, interposed, inline, and/or disposed between the media presentation device 210 and the power source 250. For example, a first power cord may be connected between the sensor 240 and the power source 250 and a second power cord may be connected between the sensor 240 to the media presentation device 210. As another example, the sensor 240 may be attached externally to a power cord connected between the media presentation device 210 and the power source 250. In some examples, the sensor 240 may include a current measurement system, such as a current transformer sensor assembly (CTSA), that measures the amount of current drawn by the media presentation device 210 from the power source 250. Other types of sensors and connections are possible.

In examples, the sensor 240 collects the power data about the power consumed by the media presentation device 210 from the power source 250. The power data collected by the sensor 240 may include power draw data and/or current draw data, for example. The power data may include, for example, electrical power consumed by the media presentation device 210 over time. The power data may be derived from continuous and/or intermittent sampling, for example. The power data may be in units of watts at a particular time granularity, such as 1-second, 2-second, 5-second, 10-second, 30-second, one-minute, five-minute, ten-minute, 30-minute, or 60-minute intervals, for example. As another example, the power data may be in units of voltage or current. Other units, levels, and/or resolutions of time granularity are possible. The power data may include, for each time interval, various statistics, for example, including one or more of an average or mean of power consumption related values for the interval, a trimmed mean of power consumption related values for the interval, a median of power consumption related values for the interval, a standard deviation of the power consumption related values during the interval, an interquartile range of power consumption related values for the interval, etc.

In examples, power data collected by the sensor 240 is communicated to the content presence determination device 270. For example, the sensor 240 may be configured to communicate the power data to the content presence determination device 270 over network 260. In other examples the power data is communicated to another server (not shown). In some examples, the sensor 240 communicates over network 260 using a communication interface, such as communications interface 106. In some examples, the power data may be communicated by a separate device (not shown), such as the separate device used by the metering device 230 to communicate the identification data to the identification server. The power data may be communicated by transmitting using a communications interface, such as communications interface 106, for example. In other examples, the power data is communicated to the content presence determination device 270 over a separate network from the network used by the metering device 230.

In some examples, the identification data (including the SNR data) communicated to the identification server and/or the power data communicated to the content presence determination device 270 are then stored in one or more databases, such as database 280. For example, the content presence determination device 270 may store the received power data in database 280. As another example, the identification server may store the identification data (including the SNR data) and/or the SNR data in the database 280. In some examples, the identification data (including the SNR data) and/or the power data are instead communicated to another server (not shown) which stores the data in one or more databases, such as database 280. For example, the identification data and/or the SNR data and the power data may be stored in the same database 280. As another example, the identification data (including the SNR data) and the power data may be stored in separate databases (not shown). Other ways of storing the identification data (including the SNR data) and the power data are possible.

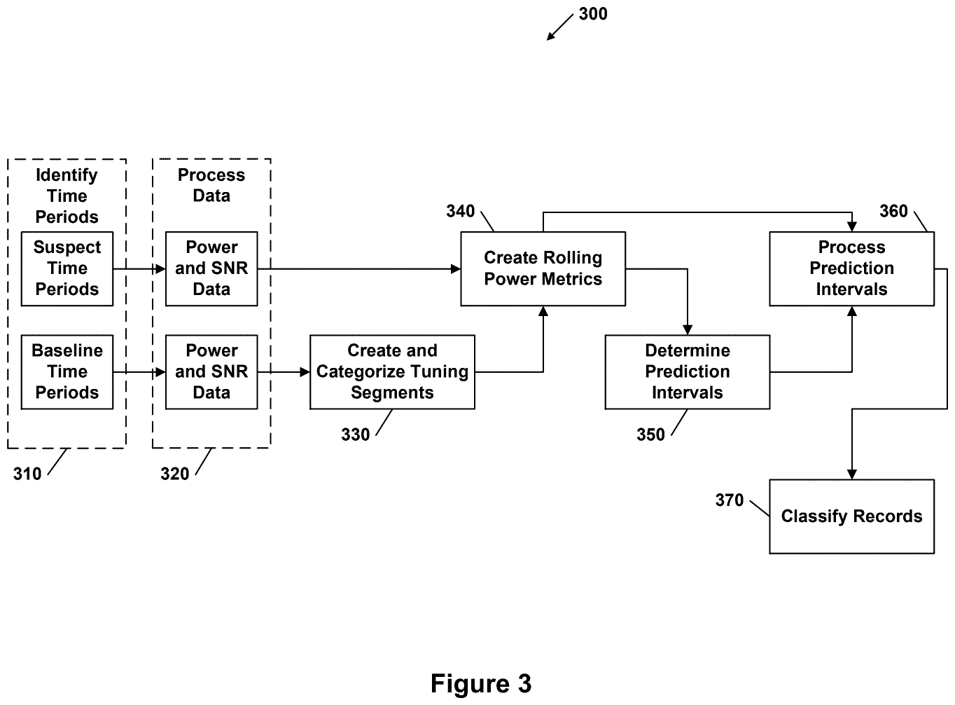

FIG. 3 illustrates a block diagram of an example content presence determination technique 300 in accordance with example embodiments. In examples, the example content presence determination technique 300 may be performed by a content presence determination system, such as content presence determination system 200. In some examples, the example content presence determination technique 300 may be performed at least by the content presence determination device 270, for example. In some examples, the content presence determination device 270 may use data stored in the database 280 to perform the example content presence determination technique 300. In some examples, the content presence determination device 270 may use data received from the sensor 240 to perform the example content presence determination process 300.

At block 310, a set of suspect time periods and a set of baseline time periods are identified. In examples, a suspect time period may correspond to a time period during which suspect audio was identified. For example, a flag, alert, or other indicator may identify a time period during which suspect audio was detected. Suspect audio may indicate degraded or missing content, for example. In some examples, a metering device, such as metering device 230, and/or an identification server may identify the presence of suspect audio. In examples, a baseline time period may correspond to a time period during which no suspect audio was identified. For example, a baseline time period may be identified as a time period during which the audio was healthy and no suspect audio was detected. In examples, and without loss of generality, a baseline time period may be, for example, a selected, predetermined, and/or arbitrary time period and a suspect time period may correspond to a time period outside of a baseline time period. That is, a baseline time period may be identified, and other, non-baseline time periods may be identified and analyzed in accordance with the techniques discussed herein, where such non-baseline time periods are treated similarly to suspect time periods, although they are not necessarily associated with suspect audio, for example.

In some examples, a suspect time period is a block of time, such as a 1-minute window, a 5-minute window, a 10-minute window, a 30-minute window, an hour window, 6-hour window, 12-hour window, a 24-hour window, a 48-hour window, a week, etc. In some examples, a baseline time period is a block of time, such as a 1-minute window, a 5-minute window, a 10-minute window, a 30-minute window, an hour window, 6-hour window, 12-hour window, a 24-hour window, a 48-hour window, a week, etc. In some examples, a suspect time period and a baseline time period are the same length. For example, a suspect time period and a baseline time period may each be 1 calendar day. In some examples, a suspect time period and a baseline time period are different lengths. For example, a suspect time period may be a 5-minute window and a baseline time period may be an hour window. Other combinations are possible. In some examples, multiple sets of suspect time periods and respective sets of baseline time periods may be identified. In some examples, the particular time periods in a first set of suspect time periods and the respective set of baseline time periods may overlap with time periods in a second set of suspect time periods and/or the respective set of baseline time periods.

Without loss of generality, the following discussion will refer to suspect time periods and baseline time periods each of 1 calendar day, but other periods of time are possible, as discussed above.

In examples, the set of suspect time periods includes one or more days. For example, the one or more days in the set of suspect time periods may include calendar days during which suspect audio was identified. As another example, the one or more days in the set of suspect time periods may include at least one calendar day during which suspect audio was identified and a number of days before and/or the at least one calendar day during which suspect audio was identified. The days before and/or after the at least one calendar day may be consecutive days, for example. In some examples, the days considered for inclusion the in the set of suspect time periods are days during which a media presentation device, such as media presentation device 210, was powered on for a threshold amount of time. For example, the threshold amount of time may be 10 minutes, 30 minutes, 60 minutes, 2 hours, 6 hours, 12 hours, etc. Such days may be referred to as, for example, MPD-on Days or TV-on Days and the intervals during which the media presentation device was powered on may be referred to as, for example, MPD-on Time or TV-on Time. In some examples, the set of suspect time periods includes a first MPD-on Day during which a suspect time period was identified and a number of MPD-on Days before and/or after the first MPD-on Day. For example, the set of suspect time periods may include the most recent MPD-on Day during which a suspect time period was identified and the two most recent MPD-on Days. As another example, the set of suspect time periods may include the three most recent MPD-on days during which a suspect time period was identified and up to 2 MPD-on Days before and after each of those three.

In examples, the set of baseline time periods includes one or more days. For example, the one or more days in the set of baseline time periods may include calendar days during which no suspect audio was identified during the calendar day. The one or more days in the set of baseline time periods may be consecutive days or non-consecutive days, for example. In some examples, similar to the days considered for inclusion in the set of suspect time periods, the days considered for inclusion the in the set of baseline time periods are days during which a media presentation device, such as media presentation device 210, was powered on for a threshold amount of time (MPD-on Days or TV-on Days). In some examples, the set of baseline time periods includes a number of most-recent MPD-on Days, where each of those MPD-on Days do not include suspect audio time periods. In some examples, the set of baseline time periods may include a number of MPD-on Days during which no suspect time period was identified within a threshold amount of time. For example, the set of baseline time periods may include up to the ten most recent MPD-on Days during which no suspect time period was identified in the past 60 days.

At block 320, data associated with the set of suspect time periods and the set of baseline time periods identified at block 310 is processed. In examples, for each day in the set of suspect time periods, SNR data is processed. In examples, for each day in the set of baseline time periods, SNR data is processed. The SNR data may be from a metering device, such as metering device 230, for example. The SNR data may be retrieved from a database, such as database 280, for example. The SNR data may be at a resolution of, for example, 1 second, 2, seconds, 5 seconds, 10 seconds, 30 seconds, 1 minute, 2 minutes, 5 minutes, 10 minutes, 30 minutes, etc. The resolution of the SNR data corresponding to the set of suspect time periods and the set of baseline time periods may be the same or different, for example. For example, the SNR data corresponding to the days in the set of suspect time periods and the SNR data corresponding to the data in the set of baseline time periods may both be at 1 minute resolution.

In some examples, processing the SNR data includes determining a rolling SNR mean. The rolling SNR mean is calculated for data points in the resolution of the SNR data over a time window, for example. For example, if the SNR data has a resolution of 1 minute, for each minute of the SNR data, the rolling mean of the SNR data is calculated over the time window. The time window may be a fixed amount, independent of the resolution of the SNR data, for example, 30 seconds, 1 minute, 2, minutes, 5 minutes, 10 minutes, 15 minutes, 30 minutes, 1 hour, etc. The time window may be a multiple of the resolution of the SNR data, for example, such as, for SNR data with 1 minute resolution, 5× (5 minutes), 10× (10 minutes), 14× (14 minutes), 15× (15 minutes), etc. In some examples, the rolling SNR mean is determined for each data point of corresponding MPD-on Time.

In some examples, the SNR data is smoothed before processing. Smoothing the SNR data may include, for example, identifying any point in the data exceeding a threshold within a number of neighboring data points and replacing it with another value. The threshold may be based on a multiple of a standard deviation of an average of the number of neighboring data points, for example. For example, the threshold may be +/−3 times the standard deviation within the number of neighboring data points. The number of neighboring data points may be, for example, 2, 3, 5, 7, 10, 12, 15, etc. The replacement value may be based on the neighboring data points, for example. For example, the replacement value may be an average of the neighboring data points.

In some examples, processing the SNR data includes categorizing the rolling SNR mean values. For example, a rolling SNR mean value above a first threshold may indicate that content is being presented by, for example, a media presentation device such as media presentation device 210. This may be called the CONTENT category, for example. As another example, a rolling SNR mean value under a second threshold may indicate that content is not being presented by, for example, the media presentation device. This may be called the NO CONTENT category, for example. As another example, a rolling SNR mean value between the first threshold and the second threshold may indicate an unknown or indeterminate result with respect to whether content is or is not being presented by, for example, the media presentation device. This may be called the UNKNOWN category, for example. In some examples, the first threshold may be, for example, a rolling SNR mean value greater than or equal to 50, 75, 80, 90, 100, etc. In some examples, the second threshold may be, for example, 60, 50, 40, 33, 25, 10, etc.

In some examples, processing the SNR data includes creating segments. The segments may be consecutive MPD-on Time having the same categorized rolling SNR mean values, for example. In examples, consecutive time periods of MPD-on Time having the same categorization are grouped into individual segments. In some examples, as illustrated in FIG. 3, the processing of SNR data to categorize the rolling SNR mean values and categorizing them into segments takes place at block 330.

In examples, for each day in the set of suspect time periods, power data is processed. In examples, for each day in the set of baseline time periods, power data is processed. The power data may include average power draw and standard deviation of the power draw, for example. The power data may be retrieved from a database, such as database 280, for example. The power data may be from a sensor, such as sensor 240, for example. The power data may be at a resolution of, for example, 1 second, 10 seconds, 30 seconds, 1 minute, 2 minutes, 5 minutes, 10 minutes, 30 minutes, etc. The resolution of the power data corresponding to the set of suspect time periods and the set of baseline time periods may be the same or different, for example. For example, the power data corresponding to the days in the set of suspect time periods and the power data corresponding to the data in the set of baseline time periods may both be at 1 minute resolution.

In some examples, processing the power data includes determining rolling power metrics. The rolling power metrics may be viewed as representing fluctuation patterns of a media presentation device, such as media presentation device 210, over time, for example. The rolling power metrics are calculated for data points in the resolution of the power data over a time window, for example. For example, if the power data has a resolution of 1 minute, for each minute of the power data, the rolling power metrics are calculated over the time window. The time window may be a fixed amount, independent of the resolution of the power data, for example, 30seconds, 1 minute, 2, minutes, 5 minutes, 10 minutes, 15 minutes, 30 minutes, 1 hour, etc. The time window may be a multiple of the resolution of the power data, for example, such as, for power data with 1 minute resolution, 5× (5 minutes), 10× (10 minutes), 15× (15 minutes), 24× (24 minutes), 30× (30 minutes), etc. In some examples, the rolling power metrics are determined for each data point of corresponding MPD-on Time. In some examples, the rolling power metrics are for consecutive time periods of MPD-on Time. In some examples, a threshold number of time periods of MPD-on Time may be missing and still considered consecutive. For example, a threshold may be at most 4 missing time periods. In some examples, the rolling power metrics are determined each segment determined based on processing the SNR data, as discussed above. The calculated rolling power metrics may include: standard deviation, interquartile range (IQR), media absolute deviation (MAD), and/or kurtosis, for example, as well as the mean and media of the standard deviation of each of these metrics.

In some examples, the power data is smoothed before processing. Smoothing the power data may be performed in a similar manner to smoothing the SNR data, as discussed above, for example.

In some examples, as illustrated in FIG. 3, the processing of power data to determine the rolling power metrics takes place at block 340.

At block 350, prediction intervals are determined. In examples, for each rolling power metric an upper bound threshold and a lower bound threshold for an associated prediction interval are determined. In some examples, an upper bound threshold and a lower bound threshold are determined for a CONTENT prediction interval associated with a particular rolling power metric. In some examples, an upper bound threshold and a lower bound threshold are determined for a NO CONTENT prediction interval associated with a particular rolling power metric. The upper bound threshold and the lower bound threshold may be determined based on a confidence interval. The confidence interval may be, for example, 75%, 80%, 90%, 95%, 97%, 99%, etc. In some examples, the confidence interval may be the same or different for the upper bound threshold and the lower bound threshold for a particular rolling power metric. In some examples, a different or a same confidence interval may be used for determining each respective upper bound threshold and lower bound threshold associated with each rolling power metric. In some examples, the upper bound threshold and/or lower bound threshold may be determined using a percentile method, such the threshold is equal to the Xth percentile of the samples for the particular rolling power metric. For example, the upper bound threshold may be the Xth percentile, where X is equal to 100.0*(alpha/2.0). As another example, the lower bound threshold may be the Xth percentile, where X is equal to 100.0*(1.0-alpha/2.0). Alpha may be 0.75, 0.8, 0.9, 0.95, 0.97, 0.99, etc., for example. In examples, bootstrap sampling or sampling with replacement is used on rolling power metrics. This may, for example, help ensure sufficient data density. In examples, the upper bound threshold and lower bound threshold are determined for the associated rolling power metrics associated with the set of baseline time periods. In some examples, the upper bound threshold and lower bound threshold are determined for the associated rolling power metrics associated with the set of suspect time periods. In some examples, a minimum number of MPD-on segments are required for determining a CONTENT prediction interval and/or a NO CONTENT prediction interval. The minimum number of MPD-on segments may be, for example, at least 10, 20, 50, 100, 200, 1000, etc. The minimum number of MPD-on segments may be the same or different for each prediction interval.

In examples, a prediction interval may be determined by extracting a number of samples from the data associated with a particular rolling power metric. In some examples, the number of samples is based on the number of data points for the particular rolling power metric. For example, the number of samples may be equal to the number of data points for the particular rolling power metric. As another example, if the number of data points is less than a threshold, such as 1000, then the number of samples is set to be the threshold, such as 1000, and sampling with replacement is used, also referred to as bootstrap resampling. As another example, if the number of data points is greater than a threshold, such as 2000, then the number of samples is set to be the threshold, such as 2000. In some examples, once the number of samples is determined and selected, the lower and upper bounds are calculated using a confidence interval. The confidence interval may be, for example, (1-alpha) %, so for a 95% confidence level, alpha is 0.05, resulting in the bounds being at the 2.5th and 97.5th percentiles of the distribution of samples.

At block 360, the prediction intervals are processed. In examples, processing the prediction intervals includes applying, for each unit of resolution in the suspect segments, each rolling power metric value to the prediction intervals associated with the baseline set of time periods. For example, for a particular minute of a suspect segment, each rolling power metric value is compared against the CONTENT and NO CONTENT prediction intervals. Based on this comparison, corresponding percentages of overlap may be determined. In some examples, the percentage of overlap represents the percentage of minutes that fall within each prediction interval.

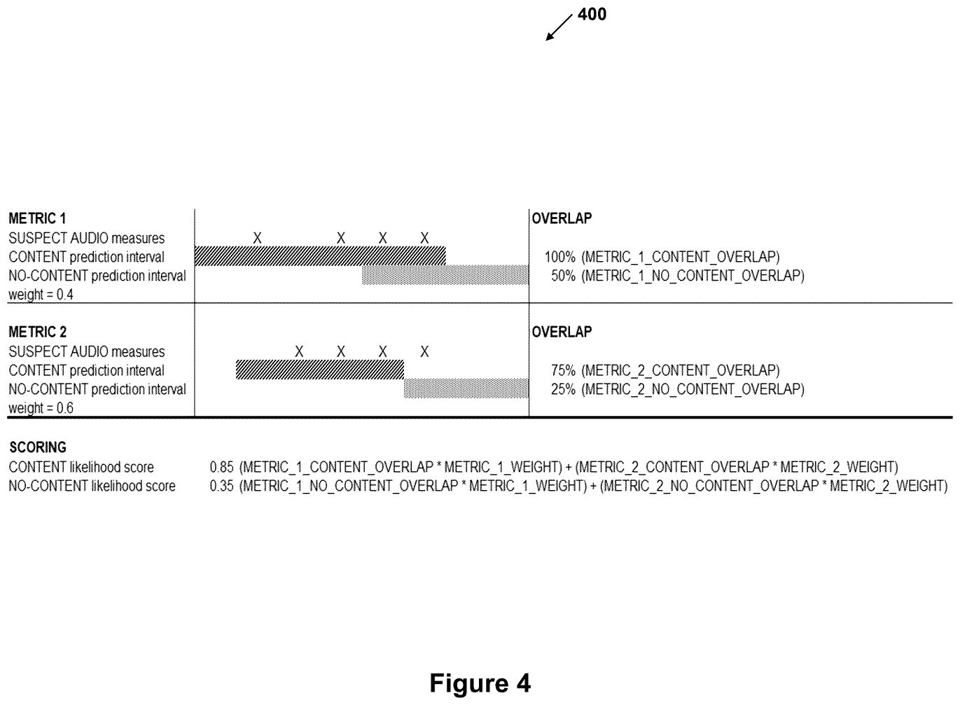

In examples, weights may be applied for each rolling power metric. The weights may correspond to a contribution of each associated rolling power metric to the determination of likelihood of content, for example. For example, a set of weights may be 0.15 for the rolling average power standard deviation, 0.20 for the rolling average power MAD, 0.20 for the rolling average power IQR, 0.05 for the rolling average power kurtosis, 0.20 for the rolling standard deviation power mean, and 0.20 for the rolling standard deviation power median. In examples, by combining the weighted percentages, an overall score for how similar the suspect segments are to the baseline CONTENT and baseline NO CONTENT prediction intervals may be determined. These scores may, in term, correspond to a likelihood that there is content being presented by a media presentation device and a likelihood that there is no content being presented by the media presentation device. FIG. 4, discussed in more detail below, provides an example of applying metrics to prediction intervals, including the use of weights with the metrics.

At block 370, suspect segments are classified as being NO CONTENT. In examples, the classification is based on the comparison of weighted percentages, discussed above. In some examples, a suspect segment is classified as NO CONTENT if less than a first threshold of suspect segments fall within the baseline CONTENT prediction interval; more than a second threshold of suspect segments fall within the baseline NO CONTENT prediction interval, and more suspect segments fall within the baseline NO CONTENT prediction interval than within the baseline CONTENT prediction interval. The first threshold may be, for example, an absolute number, a percentage, etc. For example, the first threshold may be 70%, 75%, 80%, 90%, 95%, etc. The second threshold may be, for example, an absolute number a percentage, etc. For example, the second threshold may be 50%, 66%, 70%, 75%, 90%, etc.

FIG. 4 illustrates an example 400 of applying prediction intervals in accordance with example embodiments. The example 400 includes 2 metrics, “METRIC 1” and “METRIC 2”. The CONTENT prediction intervals are shown with diagonal shading and the NO CONTENT prediction intervals are shown with dotted shading. The values of the suspect audio measures (in this example, 4 for each metric) are shown with “X”s located in relation to the prediction intervals.

As shown in example 400, for METRIC 1, all 4 suspect audio measures have values that overlap with (that is, are within) the CONTENT prediction interval. As a result, the METRIC 1 CONTENT OVERLAP value is 100% (4 of 4). 2 of the 4 suspect audio measures have values that overlap with the NO CONTENT prediction interval. As a result, the METRIC 1 NO CONTENT OVERLAP value is 50% (2 of 4).

As shown in example 400, for METRIC 2, 3 of the 4 suspect audio measure have values that overlap with the CONTENT prediction interval. As a result, the METRIC 2 CONTENT OVERLAP value is 75% (3 of 4). 1 of the 4 suspect audio measures have values that overlap with the NO CONTENT prediction interval. As a result, the METRIC 2 NO CONTENT OVERLAP value is 25% (1 of 4).

Each metric in example 400 also has an indicated weight. For METRIC 1, the weight is 0.4. For METRIC 2, the weight is 0.6.

After determining the CONTENT and NO CONTENT OVERLAP values for each metric, the CONTENT likelihood score and NO CONTENT likelihood score may be determined. In particular, as illustrated in example 400, the CONTENT likelihood score is based on a weighted average (using the indicated weights) of the CONTENT OVERLAP values for the 2 metrics: (100%*0.4)+(75%*0.6)=0.85, which is a CONTENT likelihood score of 85%.

Similarly, the NO CONTENT likelihood score is based on a weighted average of the NO CONTENT OVERLAP values for the 2 metrics: (50%*0.4)+(25%*0.6)=0.35, which is a NO CONTENT likelihood score of 35%.

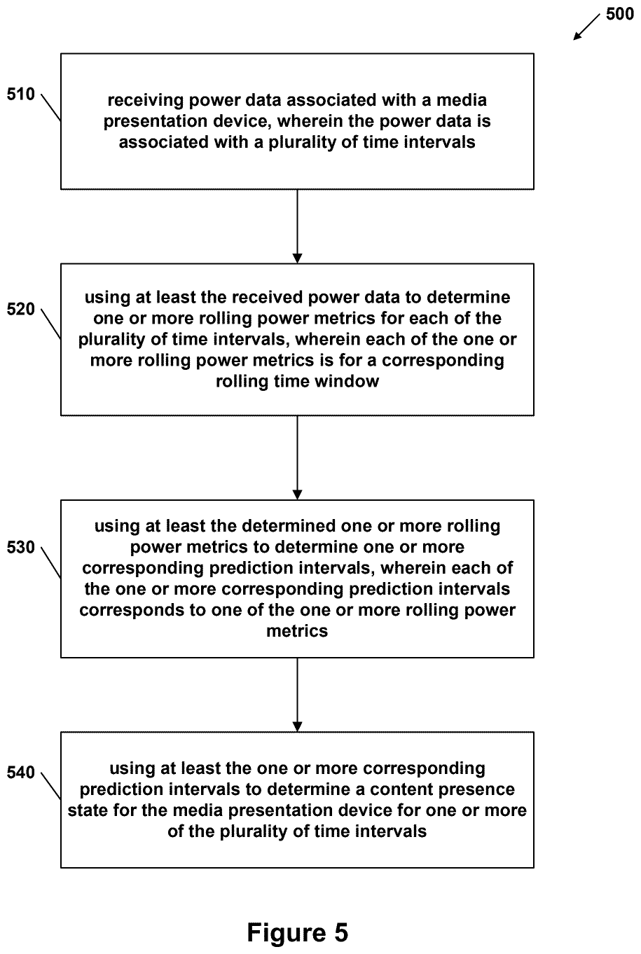

FIG. 5 illustrates a flow chart of an example method 500 of certain embodiments.

The method 500 may be a computer-implemented method, and/or may be carried out by a computing system, such as content presence determination system 200, or by one or more components thereof, and/or may be carried out in response to instructions stored on a non-transitory computer-readable medium being executed by a computing device.

At block 510, the method 500 may involve receiving power data associated with a media presentation device, wherein the power data is associated with a plurality of time intervals. In some examples, the media presentation device is a television. In some examples, the power data is generated by a sensor associated with the media presentation device. In some examples, the sensor is a current transform sensor assembly. In some examples, the power data is electrical current data. In some examples, the power data comprises average power draw data and standard deviation of the power draw data.

At block 520, the method 500 may involve using at least the received power data to determine one or more rolling power metrics for each of the plurality of time intervals, wherein each of the one or more rolling power metrics is for a corresponding rolling time window. In some examples, the one or more rolling power metrics comprise at least one of: (i) standard deviation of rolling average power draw, (ii) interquartile range of rolling average power draw, (iii) median absolute deviation of rolling average power draw, (iv) kurtosis of rolling average power draw, (v) mean standard deviation of rolling power draw, or (vi) media standard deviation of rolling power draw.

At block 530, the method 500 may involve using at least the determined one or more rolling power metrics to determine one or more corresponding prediction intervals, wherein each of the one or more corresponding prediction intervals corresponds to one of the one or more rolling power metrics. In some examples, each of the one or more corresponding prediction intervals comprises an upper bound threshold and a lower bound threshold. In some examples, each of the one or more rolling power metrics has a corresponding content prediction interval and a corresponding no content prediction interval.

At block 540, the method 500 may involve using at least the one or more corresponding prediction intervals to determine a content presence state for the media presentation device for one or more of the plurality of time intervals. In some examples, using at least the one or more corresponding prediction intervals to determine the content presence state includes applying a weighting associated with each of the one or more rolling power metrics to determine a contribution of applying the corresponding prediction interval to determine the content presence state. In some examples, the content presence state is one of (i) content present and (ii) no content present.

In some examples, the method 500 may further include: (a) receiving signal-to-noise ratio (SNR) data associated with the media presentation device; (b) using at least the received SNR data to determine rolling SNR mean data; (c) using at least the determined rolling SNR mean data to associate each of a plurality of rolling SNR values with a corresponding category; and (d) using at least the plurality of rolling SNR values to generate one or more segments, wherein each of the one or more segments comprises a subset of the plurality of rolling SNR values with a same category.

In one aspect, a tangible, non-transitory computer readable medium including instructions that, when executed, cause at least one processor to perform a set of operations is disclosed. In examples, the set of operations includes: (a) receiving power data associated with a media presentation device, wherein the power data is associated with a plurality of time intervals; (b) using at least the received power data to determine one or more rolling power metrics for each of the plurality of time intervals, wherein each of the one or more rolling power metrics is for a corresponding rolling time window; (c) using at least the determined one or more rolling power metrics to determine one or more corresponding prediction intervals, wherein each of the one or more corresponding prediction intervals corresponds to one of the one or more rolling power metrics; and (d) using at least the one or more corresponding prediction intervals to determine a content presence state for the media presentation device for one or more of the plurality of time intervals.

In one aspect, a computing system including at least one processor and a tangible, non-transitory computer readable medium including instructions that, when executed, cause the at least one processor to perform a set of operations is disclosed. In examples, the set of operations includes: (a) receiving power data associated with a media presentation device, wherein the power data is associated with a plurality of time intervals; (b) using at least the received power data to determine one or more rolling power metrics for each of the plurality of time intervals, wherein each of the one or more rolling power metrics is for a corresponding rolling time window; (c) using at least the determined one or more rolling power metrics to determine one or more corresponding prediction intervals, wherein each of the one or more corresponding prediction intervals corresponds to one of the one or more rolling power metrics; and (d) using at least the one or more corresponding prediction intervals to determine a content presence state for the media presentation device for one or more of the plurality of time intervals.

These techniques can provide various benefits, such as overcoming issues with existing detection techniques for determining whether a media presentation device is providing content during a particular time period, such as those discussed above. In some examples, the techniques discussed above improve timely, consistent, and accurate audience measurement analysis. Other improvements provided by the disclosed technical solutions would be appreciated by one of ordinary skill in the art.

The present disclosure is not to be limited in terms of the particular embodiments described in this application, which are intended as illustrations of various aspects. Many modifications and variations may be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments may be utilized, and other changes may be made, without departing from the scope of the subject matter presented herein. It will be readily understood that the aspects of the present disclosure, as generally described herein, and illustrated in the figures, may be arranged, substituted, combined, separated, and designed in a wide variety of different configurations.

With respect to any or all of the message flow diagrams, scenarios, and flow charts in the figures and as discussed herein, each step, block, and/or communication may represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages may be executed out of order from that shown or discussed, including substantially concurrently or in reverse order, depending on the functionality involved. Further, more or fewer blocks and/or operations may be used with any of the message flow diagrams, scenarios, and flow charts discussed herein, and these message flow diagrams, scenarios, and flow charts may be combined with one another, in part or in whole.

A step or block that represents a processing of information may correspond to circuitry that may be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including RAM, a disk drive, a solid-state drive, or another storage medium.

The computer readable medium may also include non-transitory computer readable media such as non-transitory computer readable media that store data for short periods of time like register memory and processor cache. The non-transitory computer readable media may further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media may also be any other volatile or non-volatile storage systems. A non-transitory computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments could include more or less of each element shown in a given figure. Further, some of the illustrated elements may be combined or omitted. Yet further, an example embodiment may include elements that are not illustrated in the figures.

Although some of the acts and/or functions described in this disclosure have been described as being performed by a particular entity, the acts and/or functions may be performed by any entity, such as those entities described in this disclosure. Further, although the acts and/or functions have been recited in a particular order, the acts and/or functions need not be performed in the order recited. However, in some instances, it may be desired to perform the acts and/or functions in the order recited. Further, each of the acts and/or functions may be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations may also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A computer-implemented method comprising:
receiving power data associated with a media presentation device, wherein the power data is associated with a plurality of time intervals;
using at least the received power data to determine one or more rolling power metrics for each of the plurality of time intervals, wherein each of the one or more rolling power metrics is for a corresponding rolling time window;
using at least the determined one or more rolling power metrics to determine one or more corresponding prediction intervals, wherein each of the one or more corresponding prediction intervals corresponds to one of the one or more rolling power metrics; and
using at least the one or more corresponding prediction intervals to determine a content presence state for the media presentation device for one or more of the plurality of time intervals.

2. The computer-implemented method of claim 1, wherein the media presentation device is a television.

3. The computer-implemented method of claim 1, wherein the power data is generated by a sensor associated with the media presentation device.

4. The computer-implemented method of claim 3, wherein the sensor is a current transform sensor assembly.

5. The computer-implemented method of claim 1, wherein the power data is electrical current data.

6. The computer-implemented method of claim 1, wherein the power data comprises average power draw data and standard deviation of the power draw data.

7. The computer-implemented method of claim 1, wherein the one or more rolling power metrics comprise at least one of: (i) standard deviation of rolling average power draw, (ii) interquartile range of rolling average power draw, (iii) median absolute deviation of rolling average power draw, (iv) kurtosis of rolling average power draw, (v) mean standard deviation of rolling power draw, or (vi) media standard deviation of rolling power draw.

8. The computer-implemented method of claim 1, wherein each of the one or more corresponding prediction intervals comprises an upper bound threshold and a lower bound threshold.

9. The computer-implemented method of claim 1, wherein each of the one or more rolling power metrics has a corresponding content prediction interval and a corresponding no content prediction interval.

10. The computer-implemented method of claim 1, wherein using at least the one or more corresponding prediction intervals to determine the content presence state comprises:
applying a weighting associated with each of the one or more rolling power metrics to determine a contribution of applying the corresponding prediction interval to determine the content presence state.

11. The computer-implemented method of claim 1, further comprising:
receiving signal-to-noise ratio (SNR) data associated with the media presentation device;
using at least the received SNR data to determine rolling SNR mean data;
using at least the determined rolling SNR mean data to associate each of a plurality of rolling SNR values with a corresponding category; and
using at least the plurality of rolling SNR values to generate one or more segments, wherein each of the one or more segments comprises a subset of the plurality of rolling SNR values with a same category.

12. The computer-implemented method of claim 1, wherein the content presence state is one of (i) content present and (ii) no content present.

13. A tangible, non-transitory computer readable medium comprising instructions that, when executed, cause at least one processor to perform a set of operations comprising:
receiving power data associated with a media presentation device, wherein the power data is associated with a plurality of time intervals;
using at least the received power data to determine one or more rolling power metrics for each of the plurality of time intervals, wherein each of the one or more rolling power metrics is for a corresponding rolling time window;
using at least the determined one or more rolling power metrics to determine one or more corresponding prediction intervals, wherein each of the one or more corresponding prediction intervals corresponds to one of the one or more rolling power metrics; and
using at least the one or more corresponding prediction intervals to determine a content presence state for the media presentation device for one or more of the plurality of time intervals.

14. The tangible, non-transitory computer readable medium of claim 13, wherein each of the one or more rolling power metrics has a corresponding content prediction interval and a corresponding no content prediction interval.

15. The tangible, non-transitory computer readable medium of claim 13, wherein using at least the one or more corresponding prediction intervals to determine the content presence state comprises:
applying a weighting associated with each of the one or more rolling power metrics to determine a contribution of applying the corresponding prediction interval to determine the content presence state.

16. The tangible, non-transitory computer readable medium of claim 13, where the set of operations further comprise:
receiving signal-to-noise ratio (SNR) data associated with the media presentation device;
using at least the received SNR data to determine rolling SNR mean data;
using at least the determined rolling SNR mean data to associate each of a plurality of rolling SNR values with a corresponding category; and
using at least the plurality of rolling SNR values to generate one or more segments, wherein each of the one or more segments comprises a subset of the plurality of rolling SNR values with a same category.

17. A computing system comprising:
at least one processor; and
tangible, non-transitory computer readable medium comprising instructions that, when executed, cause the at least one processor to perform a set of operations comprising:
receiving power data associated with a media presentation device, wherein the power data is associated with a plurality of time intervals;
using at least the received power data to determine one or more rolling power metrics for each of the plurality of time intervals, wherein each of the one or more rolling power metrics is for a corresponding rolling time window;
using at least the determined one or more rolling power metrics to determine one or more corresponding prediction intervals, wherein each of the one or more corresponding prediction intervals corresponds to one of the one or more rolling power metrics; and
using at least the one or more corresponding prediction intervals to determine a content presence state for the media presentation device for one or more of the plurality of time intervals.

18. The computing system of claim 17, wherein each of the one or more rolling power metrics has a corresponding content prediction interval and a corresponding no content prediction interval.

19. The computing system of claim 17, wherein using at least the one or more corresponding prediction intervals to determine the content presence state comprises:
applying a weighting associated with each of the one or more rolling power metrics to determine a contribution of applying the corresponding prediction interval to determine the content presence state.

20. The computing system of claim 17, where the set of operations further comprise:
receiving signal-to-noise ratio (SNR) data associated with the media presentation device;
using at least the received SNR data to determine rolling SNR mean data;
using at least the determined rolling SNR mean data to associate each of a plurality of rolling SNR values with a corresponding category; and
using at least the plurality of rolling SNR values to generate one or more segments, wherein each of the one or more segments comprises a subset of the plurality of rolling SNR values with a same category.
